(19) United States
(12) Patent Application Publication
(10) Pub. No.: US 2005/0178699 A1
(43) Pub. Date: Aug. 18, 2005

(54) Simplified and integrated method and apparatus for processing bulk mail at United State Postal service processing facilities

(75) Inventor: Steven W. Lopez, Colorado Springs, CO (US)

Correspondence Address: AKERMAN SENTERFITT, P.O. BOX 3188, WEST PALM BEACH, FL, 33402-3188, US

(73) Assignee: Technology Solutions International, Inc., Melbourne, FL (US)

(21) Appl. No.: 11/048,444

(22) Filed: Feb. 1, 2005

Related U.S. Application Data
(60) Provisional application No. 60/541,202, filed on Feb. 2, 2004.

(51) Int. Cl. G06F 7/00; B07C 5/00

(52) U.S. Cl. 209/584; 700/224

(57) ABSTRACT

The present invention relates to a system and method for processing mail for both the mailer and United States Postal Service. This system allows mailers to develop new, efficient processes for producing, combining, and distributing mailings to the USPS. The USPS may then distribute these mailing to Postal customers in a more efficient manner as a result of the new process of tender by mailers. The net effect of this method change is the increase efficiency of handling leading to stable or lower postal rates. A second primary benefit is the improvement in quality of the delivered product. The method changes utilize the integration of one or more processes, reduced handling, elimination of mechanical bundles sorter, the reduction of use and/or eventual potential elimination of sacks.

### CROSS REFERENCE TO RELATED APPLICATIONS

The present invention claims priority to U.S. Provisional Patent Application No. 60/541,202, filed Feb. 2, 2004.

### FIELD OF THE INVENTION

The present invention is directed to Mailer and United States Postal Service (USPS) operational processes related to preparing and processing bulk mailings and related systems.

### BACKGROUND OF THE INVENTION

It is a stated goal of the USPS to work with Mailers to achieve the lowest cost for processing mail from both mailer and USPS combined. This goal involves prescribing methods and setting rates to provide incentives for additional mailer work thus reducing the work requirement within a postal facility and thus reduce postal expenses. This method does not attempt to identify break-even points as it only is designed to prescribe a method that will lead to lower combined costs for both Mailers and USPS. It is the prerogative of the USPS to set rates and rules that use minimums as a boundary to describe offsetting operational costs.

The current method typically requires mailers to sort individual magazines, otherwise known in the industry as flats, into packages, otherwise known as bundles. These bundles are typically bound very tightly with stretch wrap or strapping around each bundle. Internally, the contents of the bundle may be compensated (counter-stacked), whereby the contents are rotated 180 degrees to ensure uneven binding thickness does not cause excessive bulges. The careful grouping is necessary to ensure that the integrity of the bundle is not lost during the many times the bundle is dumped by the Postal Service, an average of more than four. The process of wrapping bundles tightly and robustly to protect from the multiple processes also has the distinct disadvantage of being very labor intensive to open for single piece flat distribution. The process of mailer strapping, compensating, and wrapping is mechanical, although the equipment requires constant maintenance and the use of plastic consumables becomes expensive when dealing with the very large quantities of mail typically associated with bulk mailers of standard and periodical flats. Another disadvantage is that the plastic wrap used to wrap the bundles is difficult to dispose of environmentally after use. The process of loading the bundles onto pallets is a manual and labor intensive process due to the large number of bundles associated with bulk mailing. If volumes are not sufficient, the mailer must place the bundles into a smaller container called a sack, which requires an incremental increase in labor to process.

The bundles are typically sorted to various levels defined as Firm (a specific address), Carrier Route (a specific Letter Carrier delivery route), 5 digit (all the same 5 digit ZIP code), 3 digit (all starting with the first three digits of the ZIP code), ADC (Area Distribution Center otherwise known as two or more 3 digit ZIP codes), or BMC (Bulk Mail Center, a facility that distributes mail to multiple ADC's).

These bundles are then placed into containers that are typically sorted to a specific level, such as a delivery unit, a SCF (Section Center Facility otherwise known as a specific 3 digit ZIP code), an ADC, or a BMC.

Many small and medium size mailers that do not have the required 250 pounds for each container must use sacks as set forth by rule in the Domestic Mail Manual. The use of sacks is a difficult and expensive process for both Mailers and the USPS. The process of loading and unloading sacks is difficult and tests have shown that as many as 25% of the bundles are broken during the handling and sorting process for the sacks. When comparing sacks to pallets, an estimated 1% of the bundles from pallets are broken.

The use of sacks has long been used in the Postal Service because they offer low initial cost, compact storage and compact transportation. They have always had the problem of difficult handling on mechanized equipment, high breakage of bundles within the sack resulting in damage, and difficult container to load and unload. Until this point, the Postal Service has determined that the cost of replacing sacks with flat trays was prohibitive.

After these multiple dumping and sorting processes, the bundle is opened, which is also known as preparation of the bundle. These bundles are then placed into containers of either trays or carts.

After the USPS predefined acceptance procedures, the Postal Service will dump the contents of the container for processing on mechanized bundle distribution equipment (usually one container is typically dumped into a Small Parcel and Bundle Sorter (SPBS)). This equipment sorts mail into another container representing a smaller geographic area. Typically, this container is a hamper and is then pushed to a staging area awaiting the preparation activity. In total, a typical pallet bundle is dumped greater than 4 times on average. Bundles in sacks are dumped several additional times and handled on heavy duty mechanized sorting conveyors, resulting in the high breakage rate of sack bundles.

The elimination of sacks in favor of flat trays is timely due to the increased procurement of automated tray handling equipment, otherwise known as Low Cost Tray Sorters (LCTS) and Tray Management Systems (TMS).

The preparation activity then removes any plastic stretch wrap or strapping, and then corrects the cross stacking before placing the flats into another container, called a Flat Mail Cart, placed into staging for Automated Flat Sorting Machine (AFSM) distribution.

The AFSM is the processing operation that initiates the processing of mail pieces in a singular format after the distribution of opening, preparation of bundles. This piece of equipment typically has three separate feed stations that merge mail into a single carrousel for sortation. The process of loading the feed stations has typically required one person per feed station because of the tasks involved with taking mail out of a rolling cart where mail is stacked with the edges all in the same horizontal plane, or taking mail out of a flat tub where mail is also stacked in a horizontal plane. After removing mail from these containers one handful at a time, the handful of mail is rotated, placed on the feed table in a vertical orientation with the binding down, and moving the feed paddle that maintains the vertical orientation. The present invention changes the requirement for the one to one relationship with the feeders due to the new flat tray that allows for a semi-manual cartridge approach to loading the AFSM feeders with less than the full three person complement.

### SUMMARY OF THE INVENTION

The present invention is intended to simplify the mailers preparation by reducing the work content, reducing the number of bundles and containers, increase the amount of mail that qualifies for lower rates, and improves the ability of the USPS to process this mail. The intended consequence of this process within the USPS is to integrate the bundle distribution and mail preparation into one simpler, more efficient process that involves no dumping or redundant handling. A further consequence of this method is to reduce the damage to mail that is inherent with mechanized dumping and distribution processes, and eliminates, if possible, the expensive sorting method of opening and handling sacks.

In a typical year, mailers of advertising and news magazines, otherwise referred to as Standard and Periodical flats, will mail approximately 40 billion flats. They will use more than 1.9 billion bundles placed on more than 2.5 million pallets and 180 million sacks. It is in the best interest of both the mailers and USPS to minimize how many bundles and containers are used for tender by mailers to the USPS. The obvious extremes are very small bundles that require extensive mailer and Postal effort to prepare and very large bundles or containers that cannot be easily handled physically or mechanically.

The Postal Service has provided incentives, in the form of lower postage rates, that permit mailers with large quantities of mail to tender this mail closer to the delivery point in appropriate containers or provide a greater depth of sort such as carrier route sort. Some additional discounts involve programs, such as co-mailing and copalletization programs, that allow for combining different publications into bundles or pallet containers. This additional work by mailers lowers mailers' fees as a result of the subsequent lower Postal processing costs.

One benefit of the present invention is to simplify the mailing requirements. The current Domestic Mail Manual (DMM) is hundreds of pages of detailed requirements. Accordingly, in one aspect, the present invention provides methods to standardize and simplify operations that will satisfy streamlined DMM requirements. Standardized and simplified operations would also facilitate establishing cost based rates, a goal both mailers and the Postal Service desires.

The present invention proposes new separation rules that are designed to provide more efficient handling for both mailers and USPS as a result of the proposed method changes. The focus is to minimize the number of bundles in a manner that reduces bundle processing and preparation costs without increasing downstream operational costs. The present invention accomplishes this by implementing one or more of the following changes:
1. eliminate stretch wrap for each bundle, or an alternative embodiment, easy to cut strapping or banding may be used to retain the bundle integrity;
2. eliminate or substantially restrict the compensation (counter-stacking) of each bundle whereby the individual groups of mail pieces are rotated 180 degrees in the same plane to balance the bulging effect of bindings;
3. ensure bundles are placed on a pallet container in a specific sequence that will facilitate the loading and unloading of the container;
4. eliminate sacks through changes in pallet rules and use of existing flat trays;
5. increase the maximum size of bundles due to changed ergonomics and elimination of mechanized processing;
6. permit combining 5 digit pieces into 3 digit bundles when sorted on the same AFSM scheme;
7. permit combining 5 digit ZIP codes that are worked in the same manual scheme or same AFSM 100 scheme where indicated by USPS;
8. permit combining Carrier Route bundles in non-AFSM 5 digit bundles when separation sheets are placed to clearly identify groups;
9. permit combining carrier route bundles together when separation sheets are placed to clearly identify groups; and
10. permit container consolidation for simpler shipping process.

The implementation of one or more of these changes would position the USPS to better handle the eventual introduction of future Flat Delivery Point Processing or Flat Sorter Sequencing processing whereby future machines will minimize the need for separate carrier route bundles in small quantities.

A further benefit of this invention is that a Postal un-assembly line may have multiple configurations depending on the size of the facility and volume of pallets to be distributed thereby allowing for cost effective installations for the widely varying Postal facility sizes. A small facility may have a completely low cost, manual setup that uses a manually propelled pallet lift and gravity conveyor. A large facility may have a complex setup with automated guided vehicles (AGV) and powered tray take away system, with automatic tray labeling that interfaces with a Postal Tray Management System (TMS).

Another benefit of the present invention is the reduction of sack utilization by increasing the utilization of pallets, both by rule changes, such as lowering the minimum weight for pallets, by copalletization method changes, and by rate incentives. Once sack utilization has been reduced, the economics of replacing sacks with tubs becomes viable. The elimination of sacks would have further beneficial consequences, such as permitting BMC's to restructure their processing equipment, permitting easy expansion or consolidation of the BMC network, reducing material handling inventory, and/or liberating facility space and equipment now processing sacks.

A further benefit of the present invention is the changed staffing of the current AFSM equipment due to the semi-manual loading of the new flat tray that functions much as a cartridge to load flats. Changing the flats from a container that maintains a horizontal orientation to that of a container which maintains a vertical orientation with the binding down allows for proper cartridge loading with a simple and efficient horizontal sliding motion for larger volumes compared with the previous lift, rotate, and place that is currently associated with relatively smaller handful volumes.

The present invention provides an integrated system for mailer preparation and USPS handling including a logic for assembling bundles of flats on pallets and flat trays, a method and apparatus for integrated separating and preparing said pallets and trays, and a method and apparatus for a new flat tray and loading onto feeder operation of Automated Flat Sorter Machine otherwise known as AFSM 100. The present invention, in an alternative embodiment, also provides a system wherein one or more rule changes for mailers to simplify mail preparation are utilized. In yet another embodiment, the present invention provides a system whereby method changes and rule changes in pallet preparation will facilitate the easy reading and removal of bundles from pallets based on the level or layer they are assigned by the mailer. In still another embodiment, the present invention provides a system whereby changes eliminate stretch-wrap around individual bundles and/or the substitution of single or double strapping or banding, thereby permitting easy removal.

The present invention also provides a system wherein changes encourage elimination or minimization, depending on the “bulge” effect of binding, the cross-stacking or compensation within the bundle. In yet another embodiment, the present invention provides a system wherein changes encourage assembling bundles onto pallets in a predetermined sequence developed by USPS but containing attributes that may include, but are not limited to, one or more of the following: requiring stacking of zones ending with an even number on one side and zones ending with an odd number on the opposite side of pallet; require sequential stacking of bundles on pallets with carrier routes on bottom, AFSM zones in middle and 3 digit zones on top to balance load; require stacking of bundles in a predetermined sequence that allows for unloading in the same reverse manner; require separation of bundle layers with a separation sheet that will ensure unloading of bundles; require pallet skirt for small volume pallets that will allow for easy stacking of pallets; and/or reduction of the minimum pallet size from the current 250 pounds.

The present invention also provides, in yet another embodiment, a system wherein changes allow different bundle makeup requirements involving one or more of the following: increase the size of bundles above the current 20 lb maximum; allow combining 5 digit pieces and zones in 3 digit bundles when used on the same automated sort scheme; allow combining multiple Carrier Route bundles into one bundle with proper separation sheets; allow combining zips that are worked by the USPS in the same manual scheme; combine Carrier Route zones in non-Automated Flat Sorter Machine 100 (AFSM100) 5 digit bundles with separation sheets; increase minimum bundle size for all classes of mail from current 6 pieces and 10 pieces; and/or increase the minimum size for numeric characters that represent the ZIP code.

In still another embodiment, the present invention provides a method as described for a reverse assembly method for unloading pallets and preparing mail with a single handling, into containers that will be taken to automated distribution processing. In still another embodiment, the present invention provides a method to set up prep containers in sequence mirroring the pallet sequence. In yet another embodiment, the present invention provides an apparatus to move pallet among preparation containers on wheeled (manual or automated guided vehicle) or mechanized conveyor including an apparatus that may position the pallet at multiple locations in sequence, either automatically, semi-automatically, or manually an apparatus that may position the height of the pallet for optimum ergonomic positioning, either automatically, semi-automatically, or manually; and an apparatus that may work with one or two personnel.

In still another embodiment, the present invention provides an apparatus for a new flat tray that includes one or more of the following: easy loading by personnel into a canted, stacked orientation; easy stacking and staging of multiple containers into existing, larger USPS containers; easy transportation within larger USPS pallets and containers; easy loading of automated flat sorter machines; reduced damage to mail pieces as a result of the orientation within the container; multidirectional stacking of various size mail within the container; integration to existing USPS tray sorter equipment; integration to automated and mechanized distribution equipment such as AFSM 100 or UFSM 1000 whereby automated, semi-automated, mechanical, or manual loading may be implemented; collapsible trays or trays that may be nested when empty; and/or loading of AFSM 100 with one or two personnel instead of the current three.

In yet another embodiment, the present invention provides a process designed to reduce the usage of sacks thereby allowing the remaining use to be substituted by flat trays, thereby eliminating the need for sacks, sack sorter equipment, manual sack processing equipment and inventory. In still another embodiment, the present invention provides a method of labeling each pallet container with a barcode or other electronically scanned media that will contain essential information regarding the pallet identification and contents. This information may include, but is not limited to, pallet identification number, mail acceptance identification number, number of bundles, number of bundles by level, and/or weight. In yet another embodiment, the present invention provides a process that will use the electronically scanned information for Postal operations data recording and tracking, customer notification of Postal receipt and customer notification of postal processing status.

### BRIEF DESCRIPTION OF THE DRAWINGS

Some of the features, advantages, and benefits of the present invention having been stated, others will become apparent as the description proceeds when taken in conjunction with the accompanying drawings.

FIG. 1 Postal mail flow current and proposed illustrating simplified, integrated processing.

FIG. 2 Layout of a “reverse assembly” line, tray racks and interface with TMS tray sorter or Low Cost Tray Sorter.

FIG. 3 Description of pallet layout with defined layers.

FIG. 4 Layout of pallet with layer separation sheets and stacking skirt.

FIG. 5 Detail of new flat tray options.

FIG. 6 Description of Database with linking and combined ZIPs.

FIG. 7 An alternative sequence format embodiment using a quadrant layout.

### DETAILED DESCRIPTION OF THE PREFERRED EMBODIMENT

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention includes a method and apparatus for simplifying the processing of bulk mailings and improving the quality of bulk mailings once delivered to the customer.

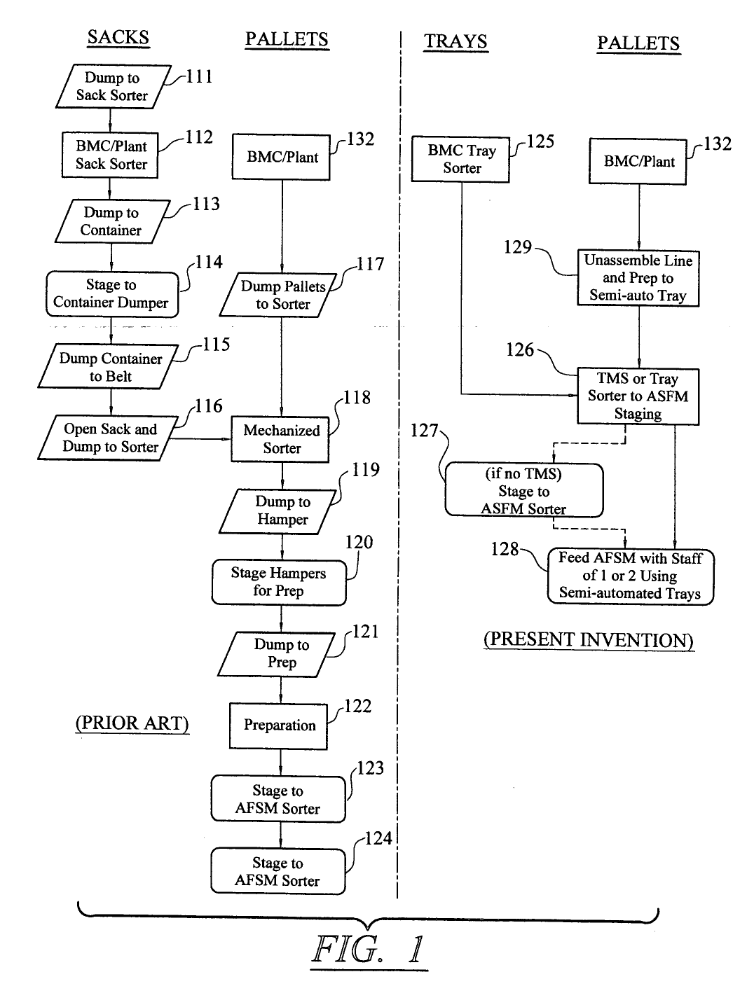

FIG. 1 illustrates the handling of containers and bundles within the Postal Service up to and including the first processing on the AFSM equipment designed for single piece processing. The process is illustrated to identify the amount of dumping, staging and handling that is typical within the current Postal environment.

In one embodiment of the present invention, the method uses two primary containers for customer preparation. In this embodiment, the containers are sacks and pallets. In this embodiment, the sacks are dumped 111 into the sack sorter 112 which also dumps the sacks 113 into a larger postal container as a part of the sorting process. The postal container is staged 114 awaiting a process whereby the larger postal container is dumped onto a belt 115 where the sacks are placed in queue to be opened and the contents dumped out 116. In some heavily mechanized facilities, the sacks bypass the larger postal container and are routed directly to a sack shakeout area. After the sacks are opened and dumped 116 the individual bundles typically travel on the mechanized conveyor belt to a mechanized bundle sorter.

Pallets are recognized to be more efficient because they can hold larger quantities of mail and are typically handled only once during the dumping process which is when they are inducted, in queue, onto multiple mechanized conveyor belts, ready for sorting on a mechanized bundle sorter, 118.

A mechanized bundle sorter 118 may be used to dump the contents into a smaller postal container, such as a hamper 119, as a part of the sorting process. These hampers may then be moved to a staging area 120 awaiting preparation activity.

After staging, the hampers may be moved to the preparation activity and dumped, typically on a mechanized conveyor belt 121. The preparation of the bundles 122 typically involves cutting and removing the stretch wrap, cutting any straps or bands, and/or correcting the compensation by orienting the individual pieces so they are facing the same direction. The loose individual pieces may then be placed into a unique postal container, such as a flat mail cart, in a uniform manner that maintains the orientation and facing of individual pieces. This flat mail cart may then be moved to a staging area 123 awaiting final movement to the AFSM sorter 124.

The AFSM sorter 124 is, in one embodiment, staffed with three people, one for each of the mechanized feeders. This staffing has been found to be appropriate for the amount of work utilized to remove individual pieces from the flat mail cart, and place onto the feed belt of the AFSM, thereby keeping the pace of the AFSM without slowing down.

In one embodiment of the present invention, the proposed method, illustrated in FIG. 1, involves the use of two containers, flat trays and pallets. The flat trays replace sacks and are much more efficient than sacks. After arrival at a facility, the flat trays may be inducted 125 into the tray sorter 126 in a manner that maintains the orientation of the tray and does not require dumping. The tray sorter 126, may be, in various alternative embodiments, a single purpose tray sorter, sometimes referred to as a Low Cost Tray Sorter (LCTS), a highly automated Postal sorter, sometimes referred to as a Tray Management System (TMS), or a multi-function sorter capable of sorting large parcels and trays typically found in Bulk Mail Centers (BMC).

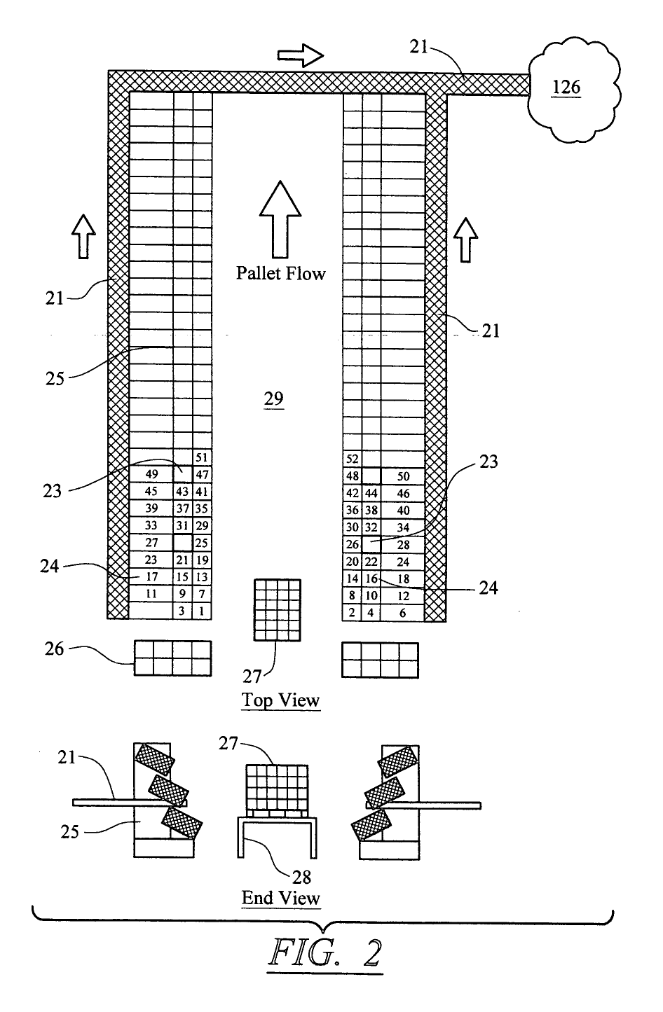

Pallets that arrive at a Postal facility 132 may be taken directly to the unassembly line 129 detailed in FIG. 2, whereby the individual bundles are loaded from the pallet into a flat tray that is then placed on the tray sorter 126.

The TMS system is a highly automated and mechanized system that collects trays from multiple locations, stages the tray, and delivers the tray to the appropriate AFSM equipment 128 at the appropriate time, thereby minimizing the labor required to otherwise handle the trays manually.

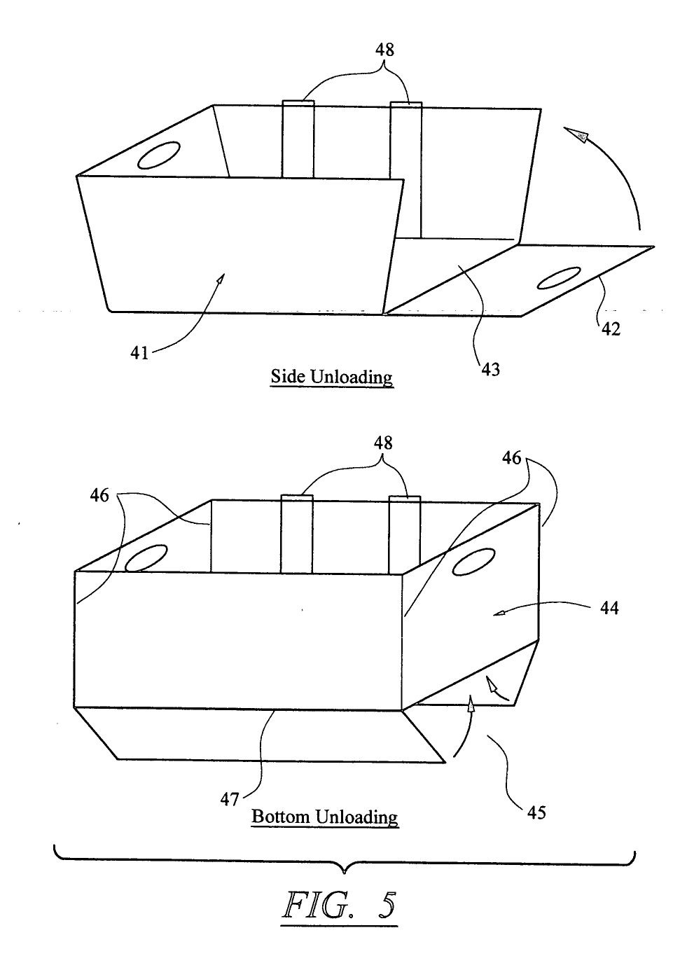

For Postal facilities without a TMS, the use of a tray sorter may generally utilize a process of intermediate movement from the tray sorter to a staging area 127 prior to movement of the aggregated Postal containers to the AFSM operation. The new AFSM operation would be efficiently staffed with only one or two personnel for the three mechanized feeders, since the flats may be loaded, vertically or horizontally, onto the mechanized AFSM feed belt at a rate that will maintain the pace of the AFSM equipment. This loading or sliding process may be facilitated by the newly designed flat tray 44 or 41 as illustrated in FIG. 5.

FIG. 2 illustrates the separation process identified on the previous flow chart as 129. FIG. 2 illustrates a plan view and an end view of a typical separation process, unit or system. This system includes both the apparatus and the method of unloading pallets in the reverse sequence from which they were prepared by mailers.

The apparatus may have multiple configurations. A beneficial configuration would include a set of racks 25 to hold the flat trays 41 or 44 canted at an optimum angle that may facilitate loading. The racks may be designed with openings 23 that may allow easy introduction of full flat trays onto the tray take away conveyor 21 that may interface with the tray sorter equipment 126. Portions of the tray take away conveyor may be inclined or elevated such that pallet movement may be facilitated.

The apparatus may include one or more Flat Mail Carts 26 that may be used to hold larger volumes of flats typically associated with 3 digit bundles.

The pallet with bundles 27 may be placed on a carrier. Examples of carriers include, but are not limited to, a conveyor, a mechanized carrier, and a non-powered wheeled carrier. In alternative embodiments, the carrier may be highly automated or may be manually controlled and propelled. This carrier may also have the ability to move the pallet vertically to adjust the height of the top bundles such that an optimum ergonomic level for manual handling may be provided. This carrier may move horizontally, between the racks 25 and may be stopped at intervals 29 that may be selected to advantageously provide the optimum distance between the bundle and the flat tray the bundle is assigned to.

FIG. 2 illustrates the positioning of flat trays in a specific sequence. Each flat tray may be the receptacle for flats with a specific ZIP code 24. In this illustration, the trays are arranged according to the ZIP code assigned, typically with ZIP codes ending with an odd number on one side of the aisle and ZIP codes ending with an even number on the other side of the aisle that the pallet moves down.

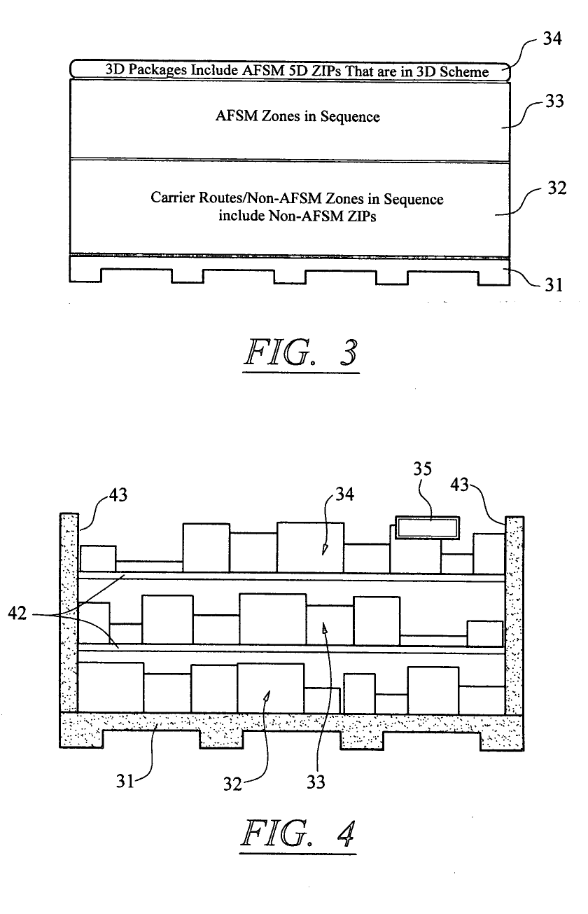

FIG. 3 illustrates the building of a pallet with bundles. The invention utilizes a common structure and sequence for placing bundles on pallets as is directed by the Postal Service and implemented by a mailer. A beneficial embodiment of this method would place carrier route bundles on the bottom 32 in an agreed sequence. Bundles for AFSM processing would form a second level 33 and would again be placed in an agreed sequence. The top level would be composed of 3 digit bundles 34 and again be placed in an agreed sequence if there are multiple 3 digits in the case of ADC or BMC containers. Each pallet may have a placard 35 containing essential information in an alpha-numeric format, an electronically scannable format, or a combination thereof. This information could be used for electronic mailer notification of receipt or processing status and Postal processing status and workload measurement indicators.

FIG. 4 illustrates physical attributes of a pallet container that may be used to provide additional structure and facilitate the method of sequencing of the present invention. Pallet levels identified as carrier routes 32 AFSM ZIP codes 33 and 3 digit bundles 34 may be separated by a flexible sheet 42 as needed to ensure easy recognition of levels. This sheet may also be used to separate layers within a level if determined to be beneficial. The use of these levels has the additional benefit of allowing the Postal personnel to focus on reading the ZIP code only without the need to read the endorsement line which identifies the type of mail within the bundle.

A further attribute for pallets may be the inclusion of a rigid pallet skirt 43 used for ensuring the integrity of the pallet particularly during movement and transportation. Another benefit would be to allow stacking of pallets that have smaller volumes or are unbalanced. The skirt may be capable of multiple uses, capable of folding flat when not in use, capable of supporting the substantial load of multiple pallets stacked above and/or capable of supporting the use of standard pallet lifting devices.

FIG. 5 illustrates a novel flat tray that may be used to facilitate the preparation, staging, transportation, and/or feeding of the AFMS. The two embodiments relate to how the tray is used on the AFSM to facilitate the feeding operation and how the tray is nested or collapsed for efficient storage when not in use.

In one embodiment, a tray 41 is loaded with flats, whereby the flat binding side is placed in the bottom of the tray. This tray would permit the horizontal unloading of flats with a simple sliding process. The tray may be hinged 48 horizontally along the bottom edge, and one side of the tray would open and close with a latching mechanism that may be easily operated with one hand or a mechanical assembly. The tray may be designed to allow for nesting of multiple trays when empty or stacking of multiple trays when full. The nesting and stacking of trays is commonly incorporated into tray design to those skilled in the art of designing storage trays.

Another embodiment of the tray 44 may be loaded with flats whereby the flat binding side is placed in the bottom of the tray. This tray design permits the loading of the AFSM feed belt by positioning the tray above the feed belt and then lifting the tray vertically while operating the latch to release the bottom doors 45. The tray may be hinged on all four vertical corners and the long horizontal bottom edge, thereby allowing the tray to fold flat when empty.

Both types of trays 41 and 44 allow for semi-automatic interface with a modified AFSM that will provide a low cost, efficient solution to single person operation of three mechanized AFSM feeders. A person knowledgeable in mechanized equipment may modify the existing AFSM feed belt in such a manner that will provide mechanized unloading of the tray when properly positioned by an operator. A semi-automatic interface that utilizes an operator to place and remove the tray is recognized to be much less expensive to develop, implement, and maintain than a fully automatic system. The semi-automatic system would be the lowest cost compared with a fully automatic system that would require an operator for other occasional ancillary tasks to ensure the consistent operation of the AFSM.

Both types of trays 41 and 44 permit the stacking using tabs 48 or other methods that a person skilled in the art will easily understand. The stacking of filled tubs has the advantage of reducing mail damage and allowing for easy containerization on widely used material handling equipment such as pallets.

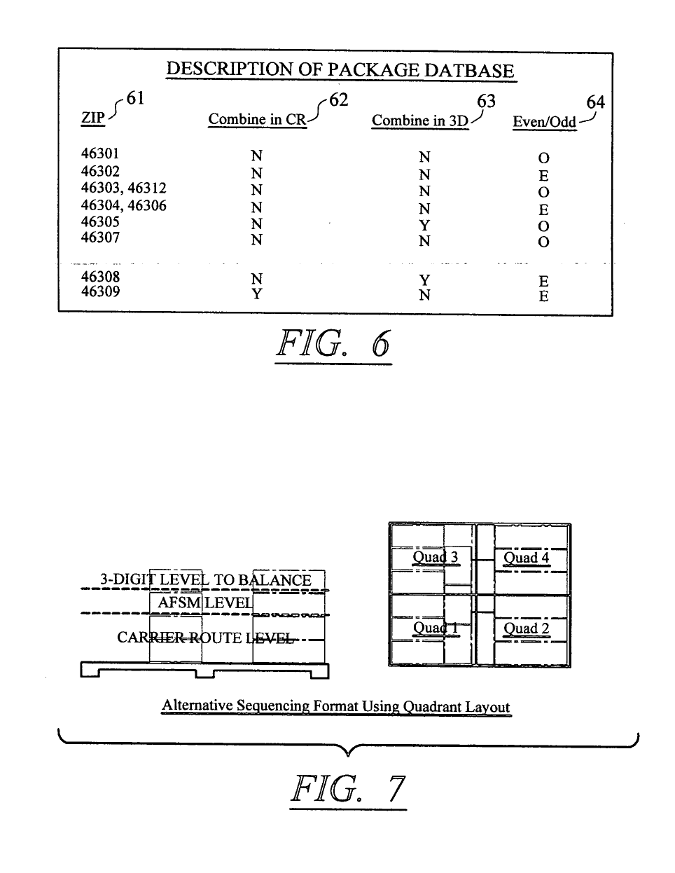

FIG. 6 illustrates, in table form, the electronic database developed by the Postal Service and shared with mailers that may communicate in sufficient detail the makeup of bundles placed on the various levels of a pallet container. The first column 61 details the sequence of ZIP codes that are placed on the pallet in both the carrier route and the AFSM level. The second column 62 describes what 5 digit ZIP codes may be placed in the carrier route level. These are typically ZIP codes that are not processed on the AFSM equipment. The third column 63 contains the 5 digit ZIP codes that may be combined within the 3 digit bundle and placed on the 3 digit level because those ZIP codes are typically worked on the same AFSM sort program as the 3 digit mail. The fourth column 64 is optionally included to provide further detail regarding which side of the pallet the bundle is placed on. This may be of value, for example, to balance the loading for selected geographic areas where there is a predominate number of large volume, even numbered ZIP codes. The use of the even and odd is not the only method that could be employed to segment the mail in a manner that will result in minimal walking and searching time for similar or neighboring ZIP codes.

FIG. 7 illustrates a layout of an alternate form of sequencing according to an alternate embodiment of the present invention. In this embodiment, the mail is clustered within quadrants on a pallet in such a manner that strict sequencing is not as rigid a requirement for Mailers to prepare. The quadrant method may be performed at multiple levels within the pallet, thereby increasing the amount of easily identified separation that is available. Levels may be delineated by cardboard or thin plastic sheeting in such a manner as to also improve the stability and/or integrity of the pallet load. This alternative manner of pallet preparation would allow more flexibility, but still permits minimal walk and reaching during the dis-assembly process.

The present invention is not specific to AFSM 100 operation but is may be used for any future machines that may process flats in delivery point sequence or in a bundle based delivery method.

The foregoing invention has be described in detail by way of illustration and example for purposes of clarity of understanding although it is obvious that certain changes and modifications may be practiced within the scope of the appended claims.

In the drawings-and specification, there have been disclosed a typical alternative embodiments of the invention, and although specific terms are employed, the terms are used in a descriptive sense only and not for purposes of limitation. The present invention has been described in considerable detail with specific reference to these illustrated embodiments. It will be apparent, however, that various modifications and changes may be made within the spirit and scope of the invention as described in the foregoing specification and as defined in the appended claims.

1. A method for integrated system for mailer preparation and USPS handling comprising:
determining at least one seperation rule for assembling bundles of flats onto one or more trays to be sent to an automated flat sorter machine for processing;
separating and preparing said flats trays according to the at least one separation rule;
loading the bundles of flats onto said flats trays; and
loading said flats trays onto one or more pallets.

2. The method of claim 1 wherein the at least one or more separation rules are used in the preparation of said flat trays to simplify mail preparation for mailers.

3. The method of claim 1 wherein bundles may be assigned to different levels of a pallet to facilitate easy reading and removal of the bundles from pallets.

4. The method of claim 1, wherein no stretch-wrap is used on individual bundles and wherein bundles are bound together using single or double strapping or banding.

5. The method of claim 1 wherein bundles are organized in a manner that eliminates or minimizes cross-stacking, counter stacking or compensation within the bundle.

6. The method of claim 1, wherein the step of determining at least one separation rule includes at least one rule selected from stacking of zones ending with an even number on one side and zones ending with an odd number on an opposite side of a pallet; sequential stacking of bundles on pallets with carrier routes on bottom, AFSM zones in middle and 3 digit zones on top to balance load; stacking of bundles in a predetermined sequence that allows for unloading in a reverse manner; separation of bundle layers with a separation sheet that will ensure unloading of bundles; a pallet skirt for small volume pallets that will allow for easy stacking of pallets; reduction of the minimum pallet size from 250 pounds; or a combination thereof.

7. The method of claim 1 wherein the carrier route bundles are isolated on a pallet in a manner that permits distribution into current standard flat tubs to zip code or delivery unit in a manner similar to 5 digit bundles.

8. The method of claim 1 wherein the at least one or more separation rules include one or more bundle makeup requirements selected from;
increasing a size of bundles above the current 20 lb maximum;
allowing the combining 5 digit pieces and zones in 3 digit bundles when used on the same automated sort scheme;
allowing the combining multiple Carrier Route bundles into one bundle with proper separation sheets;
allowing the combining zips that are worked by the USPS in the same manual scheme;
combining Carrier Route zones in non-Automated Flat Sorter Machine 5 digit bundles with separation sheets;
increasing minimum bundle size for all classes of mail from current 6 pieces and 10 pieces;
increasing the minimum size for numeric characters that represent the ZIP code; or
a combination thereof.

9. The method of claim 1, further comprising the step of reverse assembly for unloading pallets and preparing mail with a single handling, into containers that will be taken to automated distribution processing.

10. The method of claim 1, wherein prep containers are placed in a sequence that mirrors a sequence of the pallets.

11. The method of claim 1, wherein the method includes using an apparatus to position the pallets at multiple locations in sequence, further wherein the sequence is determined in a manner selected from automatically, semi-automatically, or manually.

12. The method of claim 1, wherein the method includes using an apparatus to position a height of the pallet for optimum ergonomic positioning, further wherein the height is determined in a manner selected from automatically, semi-automatically, or manually.

13. The method of claim 1 wherein the flat trays of separated flats are unloaded directly onto the AFSM feed stations by an operator loading the tray of flats to be then singulated into a sorter in a semi-automatic fashion.

14. The method of claim 1, wherein sacks are not used for loading of the bundles of flats onto pallets.

15. The method of claim 1, further comprising the step of labeling each pallet with an electronically scanned media selected from a barcode or a radio frequency identification tag; wherein the media contains information selected from pallet identification, contents pallet identification number, mail acceptance identification number, number of bundles, number of bundles by level, weight, and combinations thereof.

16. The method of claim 1, wherein the flats are bound flats having a binding side and the binding side is placed in a bottom of the flats tray.

17. The method of claim 1 wherein a database of the at least one or more separation rules is shared with mailers to inform mailers of a type of separation that is required by mailers as well as assist mailers in the planning stages onto pallets that create rules changes for USPS pallet distribution by destination facility.

18. A system for integrated system for mailer preparation and USPS handling comprising:
a system for determining at least one or more seperation rules for assembling bundles of flats onto one or more flats trays;
a separator for separating and preparing said flats trays to be sent to an automated flat sorter machine for processing using the at least one or more seperation rules;
a first loader for loading the bundles of flats onto said flats trays; and
a second loader for loading said flats trays onto one or more pallets.

19. The system of claim 18, wherein no stretch-wrap is used on individual bundles and wherein bundles are bound together using single or double strapping or banding.

20. The system of claim 18, wherein the system includes at least one or more separation rules selected from stacking of zones ending with an even number on one side and zones ending with an odd number on an opposite side of a pallet; sequential stacking of bundles on pallets with carrier routes on bottom, AFSM zones in middle and 3 digit zones on top to balance load; stacking of bundles in a predetermined sequence that allows for unloading in a reverse manner; separation of bundle layers with a separation sheet that will ensure unloading of bundles; a pallet skirt for small volume pallets that will allow for easy stacking of pallets; reduction of the minimum pallet size from 250 pounds; or a combination thereof.

21. The system of claim 18, further comprising a reverse assembly mechanism for unloading pallets and preparing mail with a single handling, into containers that will be taken to automated distribution processing.

22. The system of claim 18, further comprising an apparatus that positions the pallets at multiple locations in sequence, further wherein the sequence is determined in a manner selected from automatically, semi-automatically, or manually.

23. The system of claim 18, further comprising an apparatus that positions a height of the pallet for optimum ergonomic positioning, further wherein the height is determined in a manner selected from automatically, semi-automatically, or manually.

24. The system of claim 18, wherein sacks are not used for loading of the bundles of flat into pallets.

25. The system of claim 18, further comprising an electronically scanned media selected from a barcode or a radio frequency identification tag; wherein the media contains information selected from pallet identification, contents pallet identification number, mail acceptance identification number, number of bundles, number of bundles by level, weight, and combinations thereof.

26. The system of claim 18 wherein the carrier route bundles are isolated on a pallet in a manner capable of permitting distribution into current standard flat tubs to zip code or delivery unit in a manner similar to 5 digit bundles.

27. The system of claim 18 wherein the at least one or more separation rules include one or more bundle makeup requirements selected from:
increasing a size of bundles above the current 20 lb maximum;
allowing the combining 5 digit pieces and zones in 3 digit bundles when used on the same automated sort scheme;
allowing the combining multiple Carrier Route bundles into one bundle with proper separation sheets;
allowing the combining zips that are worked by the USPS in the same manual scheme;
combining Carrier Route zones in non-Automated Flat Sorter Machine 5 digit bundles with separation sheets;
increasing minimum bundle size for all classes of mail from current 6 pieces and 10 pieces;
increasing the minimum size for numeric characters that represent the ZIP code; or
a combination thereof.
